(19) United States
(12) Patent Application Publication
(10) Pub. No.: US 2007/0166435 A1
(43) Pub. Date: Jul. 19, 2007

(54) Chocolate chip cookie pie

(76) Inventor: Tony Edward Lambele, Valrico, FL (US)

Correspondence Address: JONATHAN E. GRANT, 2107 HOUNDS RUN PLACE, SILVER SPRING, MD, 20906, US

(21) Appl. No.: 11/333,238

(22) Filed: Jan. 18, 2006

(51) Int. Cl. A21D 13/00

(52) U.S. Cl. 426/94

(57) ABSTRACT

A cookie pie and a method of making are disclosed. The cookie pie is comprised of a shell; and a filling. The filling is comprised of a first layer comprising a first topping having a liquid consistency prior to heating, a second layer, comprising a cookie dough; and a third layer comprising a second topping.

### FIELD OF THE DISCLOSURE

The present disclosure relates to a chocolate pastry, and specifically to a pie made with chocolate chip cookie dough.

### BACKGROUND OF THE DISCLOSURE

Chocolate, in all of its various forms, is probably one of the most craved food products in the world. No other food or nonfood item is more universally accepted around the entire world than chocolate.

For unknown years or centuries, the Aztec Indians the Aztec Indians used cocoa beans in the preparation of the royal drink of the realm, “chocolatl”, meaning warm liquid. While first brought back to the New World in 1492 by Columbus in 1492, neither King Ferdinand nor Queen Isabella realized the importance of the beans laid before them. In 1519, Emperor Montezuma served “chocolatl” to the Spanish Conqueror Cortez and his soldiers in great golden goblets. Montezuma's chocolatl was very bitter, and the Spaniards did not find it to their taste. To make the concoction more agreeable to Europeans, Cortez and his countrymen sweetened the liquid with cane sugar. Eventually, others had the idea of adding other newly discovered spices from the New World, including cinnamon and vanilla and the drink was served hot.

After about a century of keeping the art of the cocoa industry a secret from the rest of Europe for nearly a hundred years, the love of chocolate and development of it use spread across Europe and then to the colonies making up what was to become The United States of America. The development of solid chocolate was followed by milk chocolate. Today, the different forms and uses of chocolate number into the hundreds or thousands of items.

U.S. Pat. No. 5,985,341 discloses chocolate articles, especially a chocolate sweet, with an improved, new kind of taste sensation. The chocolate article contains a first filling and a second filling capable of reacting with one another and separated by a barrier which is adapted to be destroyed when the chocolate article is eaten.

U.S. Pat. No. 5,858,428 discloses a container and filled food product assembly. More specifically, a syrup flavored with coffee, hazelnut, orange or the like is poured into the bottom of a shell and is then closed by a lid or seal formed by pouring on a molten mass of chocolate, sugar or the like. A quantity of creamy filling or topping of lighter or denser consistency, is deposited in side the shell on top of the the barrier or vane formed by the lid or seal.

Of course, there are many other standard uses that have become “favorites” in America. Two examples of such favorites are chocolate chip cookies and chocolate pie. Indeed, chocolate chip cookies (also known as Toll house cookies) are among the most cookie in America.

### BRIEF DESCRIPTION OF THE DISCLOSURE

The present disclosure is for a chocolate chip cookie pie. In one embodiment of the invention, a fudge topping is poured into the bottom of the shell. Cookie dough is placed in the shell, on top of the fudge topping. The “cookie pie” is then bake, and allowed to cool for 2-3 minutes. The pie is then topped with fudge topping.

In another embodiment of the disclosure, a different topping flavor is used.

In yet another embodiment of the disclosure, different cookie doughs are used.

### BRIEF DESCRIPTION OF THE DRAWINGS

Other objects and advantages of the invention will be evident from the following detailing description; with like reference numbers referring to items throughout.

FIG. 1 is a cross sectional view of the snack food in accordance with the invention.

### DESCRIPTION OF THE DISCLOSURE

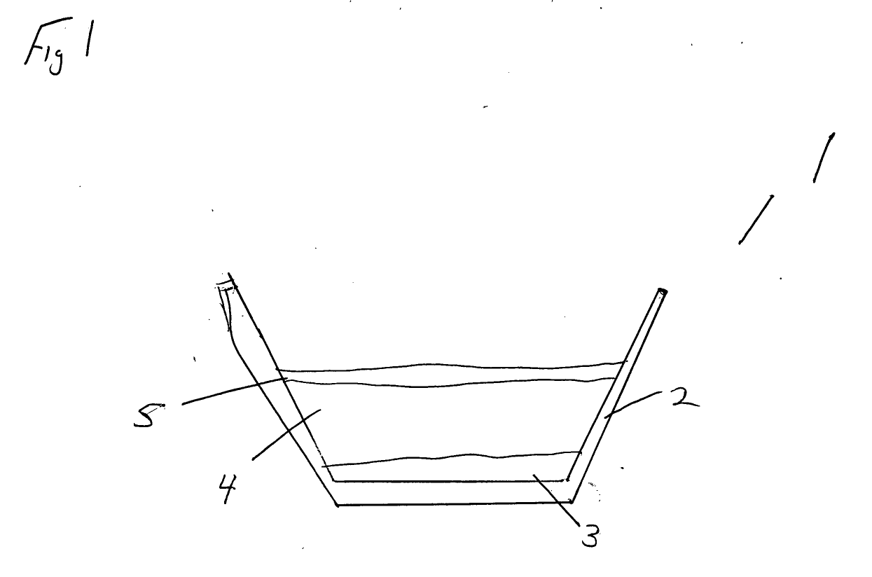

Referring to FIG. 1, a shell 2 is first placed on a cookie sheet. While the shell 2 may be comprised of pie dough, it is preferred that the shell 2 be a tart shell, and preferably a butter tart shell, commercially available through other manufacturers.

The butter tart shell 2 may be comprised of enriched flour (wheat flour, niacin, reduced iron, thiamine mononitrate, riboflavin, folic acid, etc.), vegetable shortening (contains one or more of the following partially hydrogenated oils: soybean, cottonseed), sugar, yellow corn flour, dextrose, salt, annatto (color), and/or soy lecithin (emulsifier). Water may be added if needed, for consistency and workability of the tart.

The shell 2, if manufactured along with the entire chocolate chip cookie pie 1 , may be formed from a mold after extrusion from a mixer. If the shells are formed in a mold, they may be first cooked for a short time to give them retentive strength, and then placed on a cookie sheet. Alternatively, they may remain in the mold. It is preferable that the shell be about three inches in diameter, making it easy to cook and eat. However, the shell may be from about two inches to about six inches in diameter.

After the shell 2 has been obtained, a fudge topping 3 is placed or squirted into the base of the tart shell. The fudge topping, which may use any commercial fudge such as Smucker's, Nestle's, Hersheys, etc. may be comprised of cocoa (processed), milk (or non fat milk, corn syrup fructose, glycerin, partially hydrogenated vegetable oil (soybean and cottonseed oils), salt, sodium phosphate, sodium citrate, soy lecithin, preservatives, etc.) (Smucker's Plate Scrapers Chocolate fudge flavored, herein incorporated by reference).

For a shell 2 of about three inches in diameter, about ⅙ of an ounce of fudge topping 3 forming the first layer may be used. If a larger or smaller shell is used, a proportionate variance in the amount of topping being used should be made. Alternatively, more or less fudge topping may be added for taste.

As an alternative to a fudge topping, a strawberry topping, caramel topping, a cherry topping, a raspberry topping, or some other flavored topping having a liquid consistency prior to heating may be used. Combinations of toppings may be used.

Following the addition of the fudge topping, the middle layer is formed by adding a dough. The dough that forms the second layer 4 is different from the dough that formed the tart shell. The second layer 4 is formed by adding cookie dough, added on top of the first layer topping 3. For example, a chocolate “chip” filling is added on top of the topping. The chocolate chunk cookie dough may be comprised of enriched flour, sugar, semi-sweet chocolate, vegetable shortening, eggs, margarine, a preservative, and any artificial flavorings, if necessary. The chocolate in the dough should be in chunks. In an alternative embodiment, the chocolate chip cookie dough itself is chocolate flavored.

Alternatively, a nut based cookie dough may also be used instead of chocolate chips. For example, a dough containing macadamium nuts may be used. In yet another embodiment of the invention, a chocolate flavored dough may be used, either in combination with nuts, or with no chunky additives. Similarly, the dough may also contain bits of fruit, or caramel. Additionally, combinations of these chunky doughs may be used.

The amount of dough to be positioned over the topping 3 for a three inch wide shell is preferably about two and a quarter (2.25) ounces, although this FIGURE may vary with taste and size of the shell. The amount of cookie dough added could range from about 1 ounce to three ounces.

The cookie pie is then baked for 17 minutes at 360 degrees, or until the top is of the desired darkness. Hence, cooking time and temperature are variable.

After heating, the cookie pie is removed from the oven and allowed to cool for 2-3 minutes.

For the third layer 5, a fudge topping, or some other appropriate or desired topping, which may or may not be the same topping as that found in on the first layer 3 of the filling of the cookie pie, is added on top of the second layer of the filling of the cookie pie, on top of said melted cookie dough. The amount of topping to be added may be ¼ of an ounce for a three inch shell; however, the amount of topping may be varied according to taste and size of the tart shell.

In another alternative embodiment, the filling, including the cookie dough, need not be cooked, but could be placed into the tart such that raw cookie dough is eaten.

In another alternative embodiment, a third layer is not added to the cookie dough.

While this invention has been described with reference to specific embodiments, it will be recognized by those skilled in the art that variations are possible without departing from the spirit and scope of the invention, and that it is intended to cover all changes and modifications of the invention disclosed herein for the purposes of illustration which do not constitute departure from the spirit and scope of the invention.

What is claimed is:

1) A cookie pie, said cookie pie comprising:
a) a shell; and
b) a filling, said filling comprising:
a first layer comprising a first topping having a liquid consistency prior to heating;
a second layer, comprising a cookie dough; and
a third layer comprising a second topping.

2) The cookie pie of claim 1, wherein said first layer and said second layer are heated in the shell prior to application of said top layer.

3) The cookie pie of claim 1, wherein said first topping and said second topping are the same flavor.

4) The cookie pie of claim 1, wherein said first topping is selected from the group consisting of a fudge topping, a strawberry topping, caramel topping, a cherry topping, a raspberry topping and combinations thereof.

5) The cookie pie of claim 1, wherein said second topping is selected from the group consisting of a fudge topping, a strawberry topping, a caramel topping, a cherry topping, a raspberry topping, and combinations thereof.

6) The cookie pie of claim 1, wherein said cookie dough of said second layer has chunky additives.

7) The cookie pie of claim 1, wherein said cookie dough is selected from the group consisting of chocolate chip cookie dough, macadia nut cookie dough, caramel cookie dough, caramel cookie dough, cookie dough with bits of fruit, and combinations thereof.

8) The cookie pie of claim 1, wherein said shell is a tart shell.

9) The cookie pie of claim 7, wherein said tart shell is a butter tart shell.

10) The cookie pie of claim 1, wherein said shell is comprised of a different dough than the cookie dough.

11) A method of making a cookie pie, said method comprising the steps of:
a) obtaining a tart shell;
b) adding a first topping to the inside of said to form the first layer of a filling;
c) adding a second layer, said second layer positioned on top of said first topping, said second layer being comprised of cookie dough;
d) heating said cookie pie comprising the tart shell, the first layer of said filling, and the second layer containing the cookie dough;
e) allowing said cookie pie comprising the tart shell, the bottom layer of said filling, and the middle layer containing the cookie dough to partially cool; and
f) adding a third layer comprised of a second topping.

12) A cookie pie, said cookie pie comprising:
a) a shell; and
b) a filling, said filling comprising:
a first layer comprising a first topping having a liquid consistency; and
a second layer, comprising a cookie dough.

13) The cookie pie of claim 12, further comprising a third layer, said third layer comprising a second topping.

14) The cookie pie of claim 12, wherein said first topping and said second topping are the same flavor.

15) The cookie pie of claim 12, wherein said first topping is selected from the group consisting of a fudge topping, a strawberry topping, caramel topping, a cherry topping, a raspberry topping and combinations thereof.

16) The cookie pie of claim 12, wherein said second topping is selected from the group consisting of a fudge topping, a strawberry topping, a caramel topping, a cherry topping, a raspberry topping, and combinations thereof.

17) The cookie pie of claim 12, wherein said cookie dough of said second layer has chunky additives.

18) The cookie pie of claim 12, wherein said cookie dough is selected from the group consisting of chocolate chip cookie dough, macadia nut cookie dough, caramel cookie dough, caramel cookie dough, cookie dough with bits of fruit, and combinations thereof.

19) The cookie pie of claim 12, wherein said shell is a tart shell.

20) The cookie pie of claim 7, wherein said tart shell is a butter tart shell.
